(19) United States
(12) Patent Application Publication
(10) Pub. No.: US 2024/0410411 A1
(43) Pub. Date: Dec. 12, 2024

(54) DEVICE FOR COMPENSATING FOR TOLERANCES BETWEEN TWO COMPONENTS TO BE CONNECTED TO ONE ANOTHER

(71) Applicant: Witte Automotive GmbH, Velbert (DE)

(72) Inventors: Jan Christian BENTE, Sprockhövel (DE); Volkan KANDEMIR, Essen (DE); Harry PURWIN, Ratingen (DE)

(21) Appl. No.: 18/736,675

(22) Filed: Jun. 7, 2024

(30) Foreign Application Priority Data
Jun. 8, 2023 (DE) 10 2023 205 357.8

(51) Int. Cl. F16B 21/08; F16B 39/24

(52) U.S. Cl. CPC F16B 21/08; F16B 39/24

(57) ABSTRACT

A device for compensating for tolerances between two components to be connected to one another, where the device may have a base element for fastening to one of the components. The device may also have a compensating element that is arranged to be axially movable and adjustable to compensate for tolerances relative to the base element. The compensating element may have a through-opening in which a mating connecting element for the connecting element is arranged. The mating connecting element and the compensating element are set up relative to one another in such a way that the compensating element for compensating for axial tolerances between the two components is movable relative to the base element in the direction opposite to the insertion direction.

### FIELD

The invention relates to a device for compensating for tolerances between two components to be connected to one another.

### BACKGROUND

Known devices for compensating for tolerances between two components (also known as compensating device for short) are formed by a base element or base body, a metallic threaded sleeve, and an axial compensating element, for example metallic threaded sleeves that are in a threaded engagement, for example a left-hand threaded engagement. A spring element is usually arranged in the axial compensating element and creates a frictional connection between a connecting element that is passed through the compensating device and has a further thread (right-hand thread) and the axial compensating element so that, when the connecting element is tightened, for example rotated, a torque is exerted on the axial compensating element, which causes axial adjustment of the compensating element relative to the base element in the insertion direction of the connecting screw and thus compensates for axial tolerances. For example, various screw connections are known from DE 41 02 455 A1, DE 42 28 625 C1, DE 20 2005 016 823 U1 and DE 102020204180 A1.

The object of the invention is to specify a particularly simply constructed device for compensating for tolerances between two components to be connected to one another.

The object is achieved according to the invention by a device with the features of the claims described herein for compensating for tolerances between two components to be connected to one another.

### SUMMARY

The device according to the invention for compensating for tolerances between two components to be connected to one another comprises at least one base element for fastening to a first component and a compensating element arranged in the base element in an axially movable and adjustable manner to compensate for tolerances relative to the base element, wherein the compensating element has a through-opening in which a mating connecting element for a connecting element is arranged, wherein the mating connecting element and the compensating element are set up in relation to one another in such a way that the compensating element is movable relative to the base element in the compensating direction opposite to the installation direction or insertion direction to compensate for axial tolerances between the two components. The connecting element can be inserted into or applied to the device in an installation direction or in an insertion direction in order to connect the two components.

Preferably, the compensating element has a self-locking external thread on the outside and the mating connecting element has a non-self-locking internal nut thread.

In this case, the compensating element can have an external thread having at least one, in particular non-metric, for example steep, thread turn on the outside for coupling with the base element and the mating connecting element having an internal nut thread on the inside in the through-opening, which is designed as a metric thread for engagement with the connecting element.

The at least one external thread turn has in particular a higher thread pitch than the metric thread of the inner mating connecting element. The at least one external thread turn has, for example, a steep pitch angle of greater than or equal to 5° relative to a horizontal or a thread pitch of, for example, greater than 3 mm or preferably greater than or equal to 7.5° relative to the horizontal or a thread pitch of, for example, greater than 5 mm. In other words: The external thread is thus designed as a steep thread. For example, the external thread can be formed in portions from multiple individual threads turns of the same pitch. The compensating element has, for example, an external thread that is not continuous but is formed by multiple, for example two, four or six or the like, thread turns (also referred to as thread turn portions) arranged evenly distributed in the circumferential direction. All individual thread turns or thread portions have the same pitch, which is chosen to be large enough for the external thread to form the steep thread.

The inner mating connecting element with the inner metric thread (also referred to as inner metric nut thread or metric internal nut thread) has a standardized thread having metric dimensions and, for example, a metric flank angle of 60° and a metric thread pitch for a standard thread M10 of, for example, 1.5 mm, in particular a maximum of 2.5 mm.

The advantages achieved by the invention consist in particular in the fact that a lifting force and/or a torque adjustment of a driver element is avoided by axially moving, in particular unscrewing, the compensating element from the base element against the installation direction or insertion direction of the connecting element. The device is simple and can be constructed from fewer components. In other words, the connecting element pulls on the compensating element and moves, in particular rotates, it out of the base element.

The compensating element or the mating connecting element can, for example, each be formed in one part. Both the compensating element and the mating connecting element can also be designed as one part. Preferably, the compensating element and the base element can be designed in multiple parts. For example, the multi-part compensating element is designed in such a way that its parts are connected to one another without play, in the installed state, in particular in a clamped manner, in particular detachably.

In particular, in an installed state, the compensating element is held in an axially immovable manner, in particular in a stationary manner, with respect to the mating connecting element, or the mating connecting element is held in an axially immovable manner, in particular in a stationary manner, relative to the compensating element. In other words: the compensating element and the mating connecting element are coupled together by means of an axial interference fit.

In a first possible embodiment, the mating connecting element and the compensating element can be coupled to one another in a form-locking manner. For example, the mating connecting element can be designed as a threaded nut having an internal thread, wherein the mating connecting element can have a stop flange on the one side and a radial shoulder on the other side for coupling with the compensating element in a form-locking manner.

The compensating element can preferably be arranged so as to be axially immovable (=axially fixed or axially tight) between the, in particular radial, stop flange and the, in particular radial, shoulder or projection.

As a result of such a form-locking connection, during installation and insertion of the connecting element, in particular a screw or a screw element, which connecting element has an external thread and is inserted into the mating connecting element, in particular a nut element, in particular when tightening, for example rotating, the connecting element, a torque is exerted on the compensating element via the mating connecting element, which causes the compensating element to be axially unscrewed from the base element counter to the insertion direction of the connecting element and thus compensates for axial tolerances. Such a device is particularly suitable for use on a fuel filler flap, a headlight, a tail light or the like.

In a second possible embodiment, the mating connecting element can be axially clamped against the compensating element.

For example, the compensating element on an inner side of the through-opening and/or the mating connecting element on an outer side of the outer circumference can have at least partially conically extending (=conical) clamping surfaces.

Alternatively, the mating connecting element can be axially clamped against a stop ring fixed in the through-opening or a stop flange on an inner wall of the through-opening of the compensating element.

In a further embodiment, the mating connecting element can be designed as a threaded nut having an internal thread and a radial shoulder. The compensating element can be designed with a counter-shoulder for coupling with the shoulder of the threaded nut in a form-locking manner. When installed, the radial shoulder of the mating connecting element and the shoulder of the threaded nut engage with each other so that the mating connecting element and the threaded nut are axially immovable relative to each other.

In the case of axial clamping of the mating connecting element and the compensating element, the compensating element can, for example, also be designed to be radially outwardly expandable and thereby engage the base element without play. Such a radially expandable design of the compensating element allows for simple compensation of radial tolerances or a radial play between the base element and the compensating element.

Furthermore, the base element can be formed separately and have a coupling interface for the first component. Alternatively, the base element can be integrated or pre-installed in the first component.

### DESCRIPTION OF THE FIGURES

Exemplary embodiments of the invention are explained in more detail with reference to the drawings. In the figures:

FIG. 1 shows a schematic sectional representation of a first embodiment of a compensating element with a mating connecting element as a pre-installed partial installation module of a device for compensating for tolerances,

FIG. 2 shows a schematic perspective representation of the compensating element with the pre-installed mating connecting element as shown in FIG. 1,

FIG. 3 shows a schematic perspective representation of a component to be connected having an integrated basic element,

FIGS. 4 to 7 show an installation sequence for connecting two components by means of a device for compensating for tolerances according to the first embodiment,

FIG. 8 shows a schematic exploded representation of a second embodiment of a compensating element with a mating connecting element as a pre-installable partial installation module of a device for compensating for tolerances,

FIG. 9 shows a schematic perspective representation of the second embodiment as shown in FIG. 8,

FIG. 10 shows a schematic sectional representation of the second embodiment as shown in FIG. 8,

FIG. 11 shows a schematic sectional representation of a third embodiment of a compensating element with a mating connecting element as a pre-installable partial installation module of a device for compensating for tolerances,

FIG. 12 shows a schematic exploded representation of the third embodiment as shown in FIG. 11,

FIG. 13 shows a further schematic exploded representation of the third embodiment as shown in FIGS. 11 and 12,

FIG. 14 shows a schematic perspective representation of the third embodiment as shown in FIGS. 11 to 13,

FIG. 15 shows a schematic sectional representation of a fourth embodiment of a compensating element with a mating connecting element as a pre-installable partial installation module of a device for compensating for tolerances,

FIG. 16 shows a further schematic sectional representation of the partial installation module with a screwed-in connecting element according to the fourth embodiment as shown in FIG. 15,

FIG. 17 shows a schematic perspective representation of the fourth embodiment as shown in FIG. 16,

FIG. 18 shows a schematic sectional representation of a fifth embodiment of a compensating element with a mating connecting element as a pre-installable partial installation module of a device for compensating for tolerances,

FIG. 19 shows a schematic perspective representation of the fifth embodiment as shown in FIG. 18,

FIG. 20 shows a schematic exploded representation of the fifth embodiment as shown in FIG. 18 with a separate base element and a component to be connected,

FIG. 21 shows a schematic perspective representation of the fifth embodiment as shown in FIG. 20 in the assembled state,

FIG. 22 shows a schematic side view of the fifth embodiment as shown in FIG. 20 with a separate base element and without a component in the assembled state,

FIG. 23 shows a schematic sectional representation of a sixth embodiment of a compensating element with a mating connecting element as a pre-installable partial installation module of a device for compensating for tolerances,

FIGS. 24 to 27 show an installation sequence for connecting two components by means of a device for compensating for tolerances according to the sixth embodiment,

FIG. 28 shows a schematic sectional representation of a seventh embodiment of a compensating element with a mating connecting element as a pre-installable partial installation module of a device for compensating for tolerances,

FIG. 29 shows a schematic perspective view of the seventh embodiment,

FIG. 30 shows a schematic sectional representation of an eighth embodiment of a compensating element with a mating connecting element as a pre-installable partial installation module of a device for compensating for tolerances, and

FIG. 31 shows a schematic perspective view of the eighth embodiment.

### DETAILED DESCRIPTION

Parts corresponding to one another are provided with the same reference signs in all the drawings.

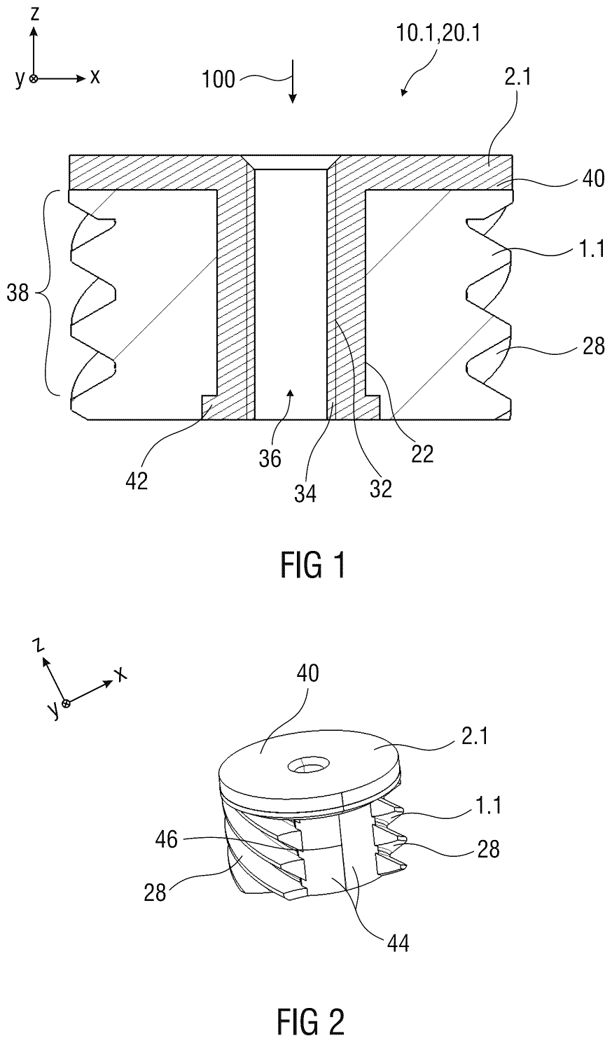

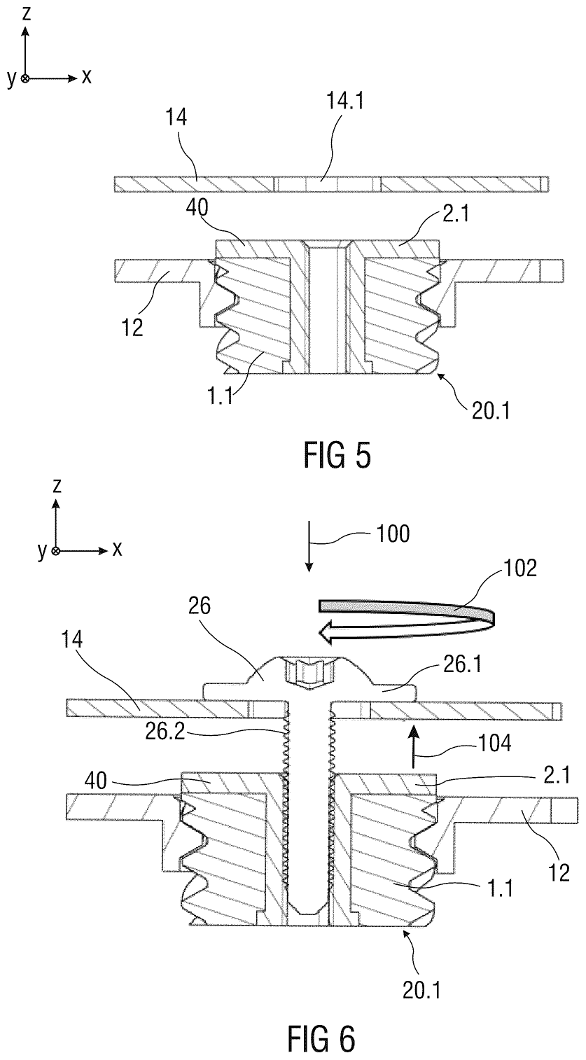

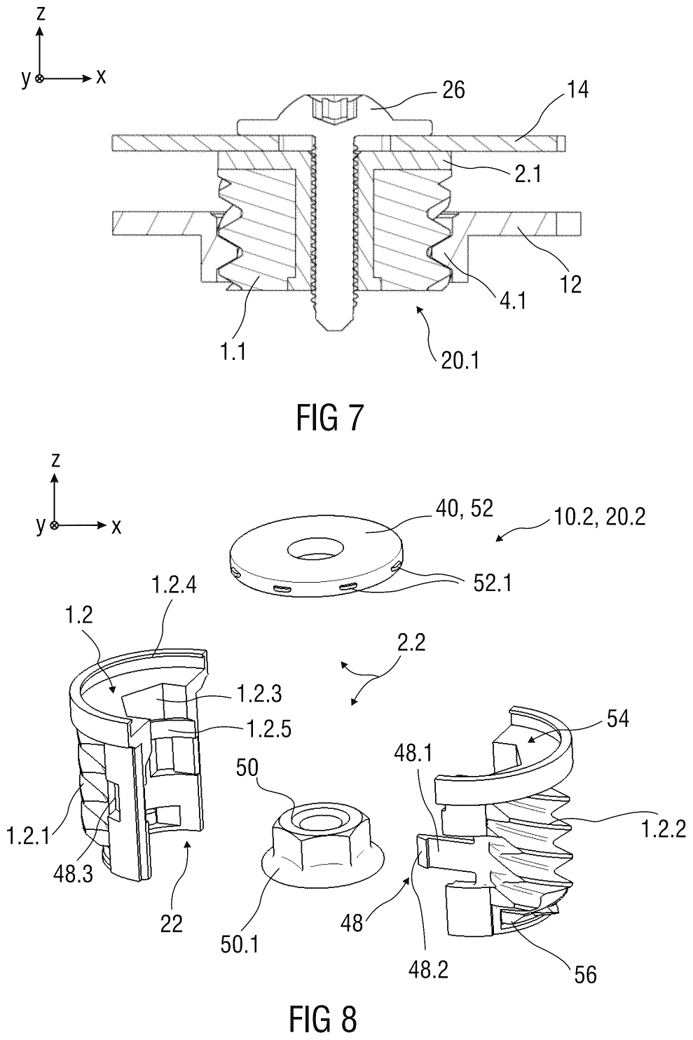

FIG. 1 shows a schematic sectional representation of a first embodiment of a compensating element 1.1 with a mating connecting element 2.1 as a pre-installed partial installation module 10.1 of a device 20.1 (shown in FIGS. 6, 7) for compensating for radial and/or axial tolerances of two components 12 and 14 to be connected to one another (shown in FIGS. 5 to 7).

The compensating element 1.1 has a first through-opening 22 in which the mating connecting element 2.1 for a connecting element 26 (shown in FIGS. 6 and 7) is arranged. The compensating element 1.1 further has an external thread 28, in particular a steep external thread 28, for coupling to a base element 4.1, in particular with an internal thread 30.

In the first embodiment, the mating connecting element 2.1 is designed as a first nut element 32. The mating connecting element 2.1 is constructed as a hollow cylinder and has a second through-opening 36 arranged coaxially to the first through-opening 22 of the compensating element 1.1.

On the inside of the second through-opening 36, an internal nut thread 34, in particular a metric thread, is formed, into which the connecting element 26 screwably engages during installation.

The inner mating connecting element 2.1 with the inner metric thread (also referred to as inner metric nut thread 34 or metric internal nut thread 34) has a standardized thread having metric dimensions and, for example, a metric flank angle of 60° and a metric thread pitch for a standard thread M10 of, for example, 1.5 mm, in particular a maximum of 2.5 mm.

In particular, in an installed state, the compensating element 1.1 is held in an axially immovable manner, in particular in a stationary manner, with respect to the mating connecting element 2.1. Alternatively, the mating connecting element 2.1 can be held in an axially immovable manner, in particular in a stationary manner, with respect to the compensating element 1.1. In other words: The compensating element 1.1 and the mating connecting element 2.1 are coupled to each other by means of an axial interference fit 38.

In the assembled state, the mating connecting element 2.1 is coupled to the compensating element 1.1 in a form-locking manner according to the first embodiment.

For example, the mating connecting element 2.1 has on the one hand a, in particular radial, stop flange 40 and on the other hand a, in particular radial, shoulder 42 for the coupling with the compensating element 1.1 in a form-locking manner. On a circumferential side of the first through-opening 22, the compensating element 1.1 has a profile complementary to the stop flange 40 and the shoulder 42, so that these are coupled to one another by means of the axial interference fit 38.

Instead of the axially fixed mating connecting element 2.1, which is coupled to the compensating element 1.1 in the interference fit 38, the mating connecting element 2.1 can be integrated into the through-opening 22 of the compensating element 1.1, in particular injected, clipped or pressed in or formed in one piece with the compensating element 1.1.

The compensating element 1.1 is arranged between the stop flange 40 and the shoulder 42 or projection in an axially immovable manner (=axially fixed or axially tight).

The second through-opening 36 can be chamfered in the insertion direction 100 of the connecting element 26 (shown in FIGS. 6 and 7), in particular for better insertion of the connecting element 26 into the mating connecting element 2.1.

FIG. 2 shows a schematic perspective representation of the compensating element 1.1 with the pre-installed mating connecting element 2.1 as a partial installation module 10.1 according to FIG. 1. The external thread 28 of the compensating element 1.1 is formed in regions and can be interrupted by smooth circumferential regions 44. In particular, the compensating element 1.1 has two opposing regions with the external thread 28 and two opposing regions with the smooth circumferential regions 44.

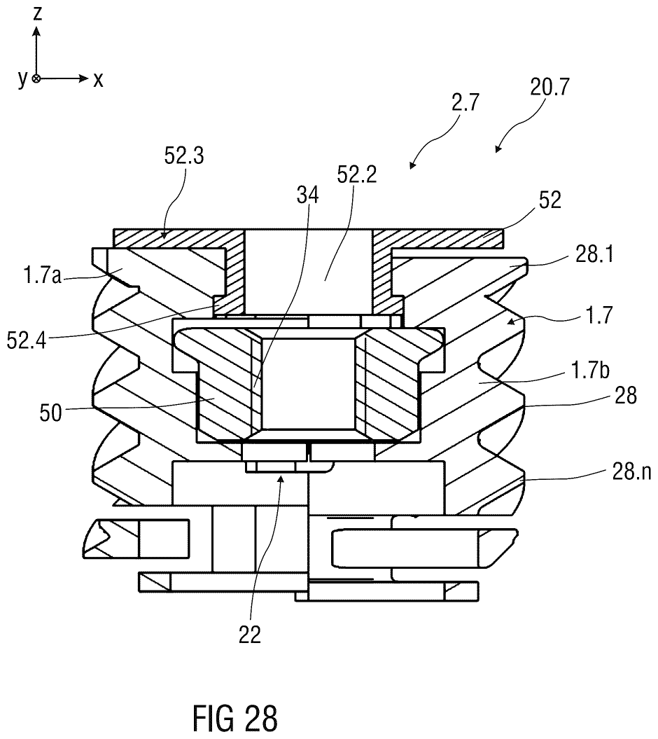

The particular external thread 28 is designed in particular as a steep thread. For example, the external thread 28 can be formed in portions from multiple individual thread turns 28.1 to 28.n (shown in more detail in FIGS. 28 to 31) of the same pitch. The external thread 28 is, for example, not continuous, but has multiple, for example two, four or six or the like, thread turns 28.1 to 28.n (also referred to as thread turn portions) arranged evenly distributed in the circumferential direction. All individual thread turns 28.1 to 28.n or thread portions have the same pitch, which is chosen to be large enough for the external thread 28 to form the steep thread.

The at least one external thread turn 28.n has in particular a higher thread pitch than the metric internal nut thread 34 of the inner mating connecting element 2.1. The at least one external thread turn 28.n has, for example, a steep pitch angle of greater than or equal to 5° relative to a horizontal or a thread pitch of, for example, greater than 3 mm or preferably greater than or equal to 7.5° relative to the horizontal or a thread pitch of, for example, greater than 5 mm.

For the coupling of compensating element 1.1 and mating connecting element 2.1 in a form-locking manner, the compensating element 1.1 is designed in multiple parts, in particular in two parts. For example, the compensating element 1.1 is formed from two half-shells, between which the one-part hollow-cylindrical mating connecting element 2.1 is first arranged during installation and then the two half-shells are releasably connected to one another, for example clipped or locked, by arranging the mating connecting element 2.1 in the first through-opening 22 of the compensating element 1.1. In the assembled state, the half-shells lie flush against each other at a dividing line 46.

The stop flange 40 is flush with an outer circumference of the compensating element 1.1, in particular the external thread 28 and the smooth circumferential regions 44.

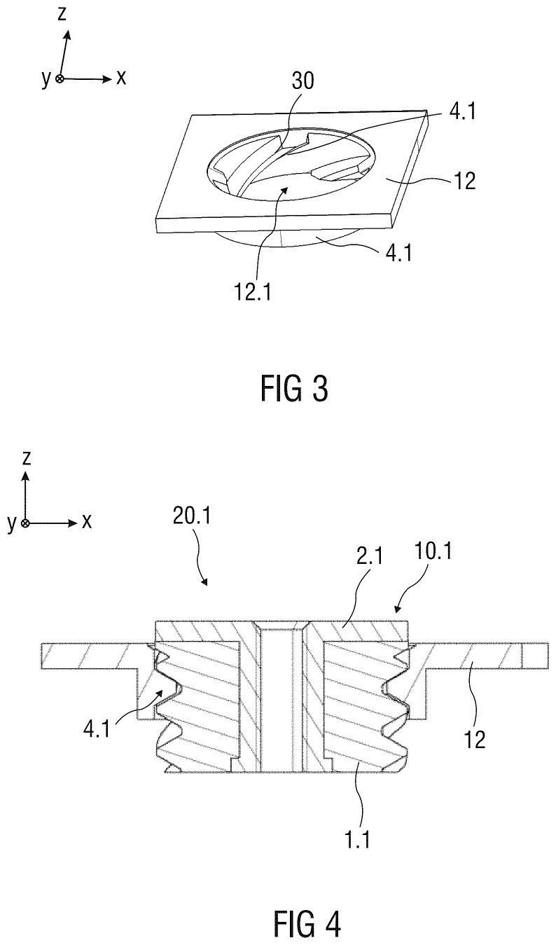

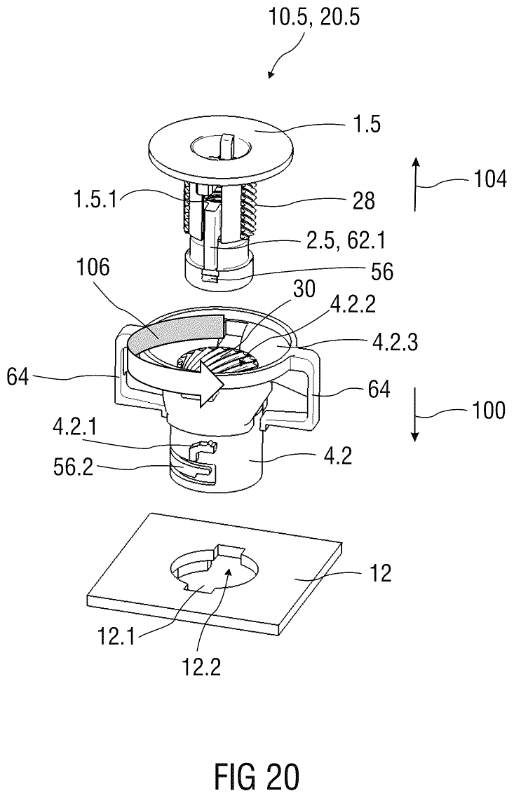

FIG. 3 shows a schematic perspective representation of the component 12 to be connected to the integrated base element 4.1, which has the internal thread 30 for the connecting element 26. The component 12 can be plate-shaped or disk-shaped or have another shape. The base element 4.1 can be formed separately. The compensating element 1.1, the mating connecting element 2.1 and a separate base element 4.2 (shown by way of example in FIGS. 20 to 22) can be assembled as a partial installation module 10.5, as shown in FIG. 22.

For the tolerance-compensating connection of the component 12 to the other component 14, the component 12 has a component opening 12.1 for receiving the partial installation module 10.1 according to FIGS. 1 and 2, as shown in FIG. 4.

FIGS. 4 to 7 show an installation sequence for connecting the two components 12 and 14 by means of the device 20.1 for compensating for tolerances according to the first embodiment.

The component 12 has the integrated basic element 4.1. The partial installation module 10.1 comprising the compensating element 1.1 and the pre-installed mating connecting element 2.1 is installed in the component 12, in particular in the component opening 12.1 and in the base element 4.1 integrated on the inside of the component opening 12.1, as shown in FIG. 4.

According to FIG. 5, the component 12 having the installed compensating element 1.1 and the installed mating connecting element 2.1 is brought into position relative to the other component 14. The other component 14 can have a larger component opening 14.1 due to the stop flange 40. This allows for radial compensation of component tolerances.

According to FIG. 6, the connecting element 26, in particular a screw, is inserted into the mating connecting element 2.1 in the insertion direction 100, in particular screwed in and thereby rotated, for example, according to arrow 102.

The connecting element 26 rotates into the internal nut thread 34 until a head 26.1 of the connecting element 26 comes into contact with the other component 14. When the connecting element 26 is further tightened and rotated, a torque is exerted on the compensating element 1.1 via the mating connecting element 2.1, which causes the compensating element 1.1 to be axially unscrewed from the base element 4.1 against the insertion direction 100 of the connecting element 26 in the compensating direction 104 and thus compensates for axial tolerances until the stop flange 40 rests against the component 14.

FIG. 7 shows the device 20.1 in the final installed state, in which the connecting element 26, the mating connecting element 2.1 and the component 14 are clamped together and the axial tolerances are compensated for. The component 12 is connected to the compensating element 1.1 via the base element 4.1 in a form-locking manner.

FIG. 8 shows a schematic exploded representation of a second embodiment of a compensating element 1.2 with a mating connecting element 2.2 as a pre-installable partial installation module 10.2 of a device 20.2. The device 20.2 of this second embodiment differs only in the design of the compensating element 1.2 and the mating connecting element 2.2. The functions and installation sequence of the device 20.2 according to the second embodiment are analogous to the device 20.1 of the first embodiment.

The compensating element 1.2 is designed in multiple parts, in particular in two parts. The compensating element 1.2 comprises two housing shells 1.2.1 and 1.2.2, which can be coupled to one another by means of a coupling connection 48. The coupling connection 48 can, for example, be designed as a latching connection and can, for example, have flexible latching arms 48.1 having latching hooks 48.2 and complementary latching receptacles 48.3, into which the latching hooks 48.2 engage in a form-locking and/or force-locking manner. Alternatively, the coupling connection 48 can be designed as a snap connection, a clip connection, a bayonet connection or the like.

The mating connecting element 2.2 is designed in multiple parts, in particular in two parts. The mating connecting element 2.2 can in particular have a second nut element 50. The second nut element 50 is, for example, a hexagonal nut having a radial collar 50.1, which serves as a shoulder 42 for the axial interference fit 38 of the compensating element 1.2 and the mating connecting element 2.2. The radial collar 50.1 engages a complementary stop surface, in particular a conical clamping surface 1.2.5, which projects radially inwardly and conically into the first through-opening 22.

The compensating element 1.2 has a receptacle 1.2.3 having an inner contour complementary to the outer contour of the second nut element 50. The outer contour and the inner contour are arranged in such a way that the second nut element 50 is held in the receptacle 1.2.3 in a rotationally fixed manner.

The stop flange 40 of the axial interference fit 38 is designed as a separate stop ring 52. The stop ring 52 is arranged and held in a form-locking and/or force-locking manner in a front-side receptacle 54 of the compensating element 1.2. The stop ring 52 has, for example, multiple latching lugs 52.1 distributed on its outer circumference, in particular symmetrically. The latching lugs 52.1 engage in a circumferential latching edge 1.2.4 or in latching receptacles 48.3 (not shown in detail) of the compensating element 1.2 in a form-locking and/or force-locking manner.

In addition, the device 20.2 can have a transport lock 56 for the loss-proof arrangement of the compensating element 1.2 and the mating connecting element 2.2. The transport lock 56 can, for example, be designed as a locking arm 56.2 that is flexible inward into the first through-opening 22.

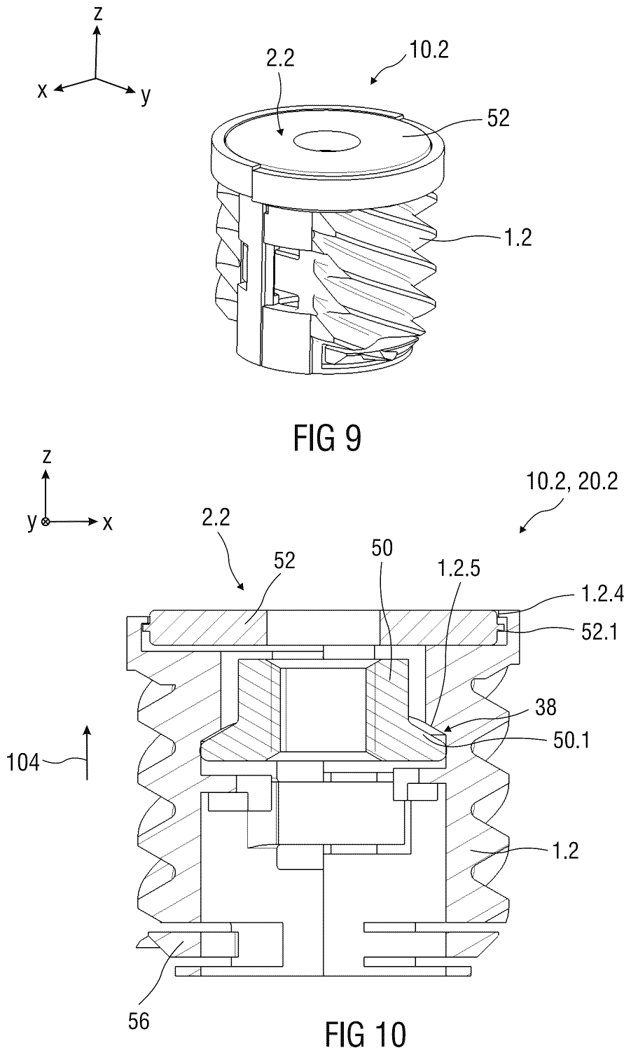

FIG. 9 shows a schematic perspective representation of the second embodiment of the partial installation module 10.2 according to FIG. 8 in the assembled state of the compensating element 1.2 and the mating connecting element 2.2 made up of a separate stop ring 52 and a second nut element 50 (shown in FIG. 8).

FIG. 10 shows a schematic sectional representation of the second embodiment of the partial installation module 10.2 of the device 20.2 according to FIGS. 8 and 9.

The second nut element 50 as a hexagonal nut is axially fixed with the radial collar 50.1 on the stop surface or clamping surface 1.2.5. For this purpose, the radial collar 50.1 engages the complementary stop surface or clamping surface 1.2.5. The radial collar 50.1 and the clamping surface 1.2.5 can, for example, be beveled and interlock in a wedge shape (=axial interference fit 38).

The latching lugs 52.1 of the separate stop ring 52 engage under the latching edge 1.2.4 of the compensating element 1.2. During assembly, in particular during clamping, of the device 20.2 according to the installation sequence according to FIGS. 6 and 7, the second nut element 50 is clamped against the stop ring 52 when the connecting element 26 is inserted. As a result, the compensating element 1.2 is clamped between the stop ring 52 and the second nut element 50 without play. Furthermore, one side of the compensating element 1.2 is displaced relative to the second side, so that a play between the component 12 with the integrated base element 4.1 and the compensating element 1.2 is axially compensated in the compensation direction 104.

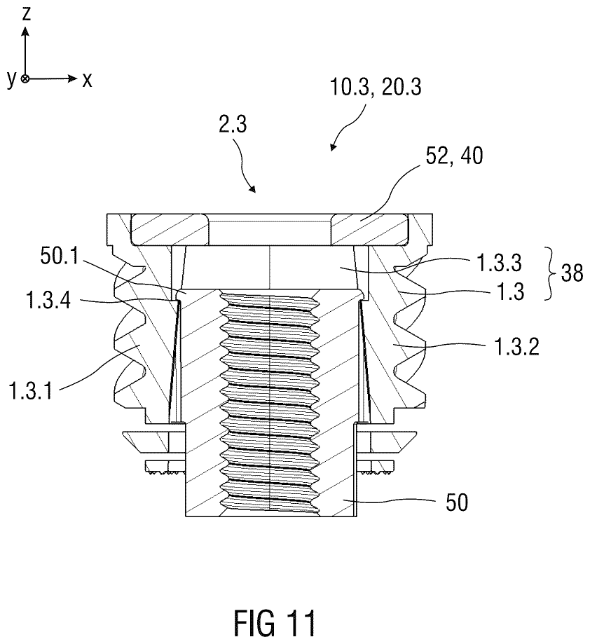

FIG. 11 shows a schematic sectional representation of a third embodiment of a compensating element 1.3 with a mating connecting element 2.3 as a pre-installable partial installation module 10.3 of a device 20.3 for compensating for tolerances.

The device 20.3 of this third embodiment differs only in the design of the compensating element 1.3 and the mating connecting element 2.3. The functions and installation sequence of the device 20.3 according to the third embodiment are analogous to the device 20.1 of the first embodiment.

The compensating element 1.3 is designed in multiple parts, in particular in two parts. The compensating element 1.3 comprises two housing shells 1.3.1 and 1.3.2, which can be coupled to one another by means of a coupling connection 48 described above.

The compensating element 1.3 has conical clamping surfaces 1.3.3 as its inner contour.

The mating connecting element 2.3 comprises the separate stop ring 52 as a stop flange 40 of the axial interference fit 38.

The mating connecting element 2.3 further comprises the second nut element 50, which has a radial latching clip 50.2 that engages in a stop surface 1.3.4 for the axial interference fit 38 of the compensating element 1.3 and the mating connecting element 2.3.

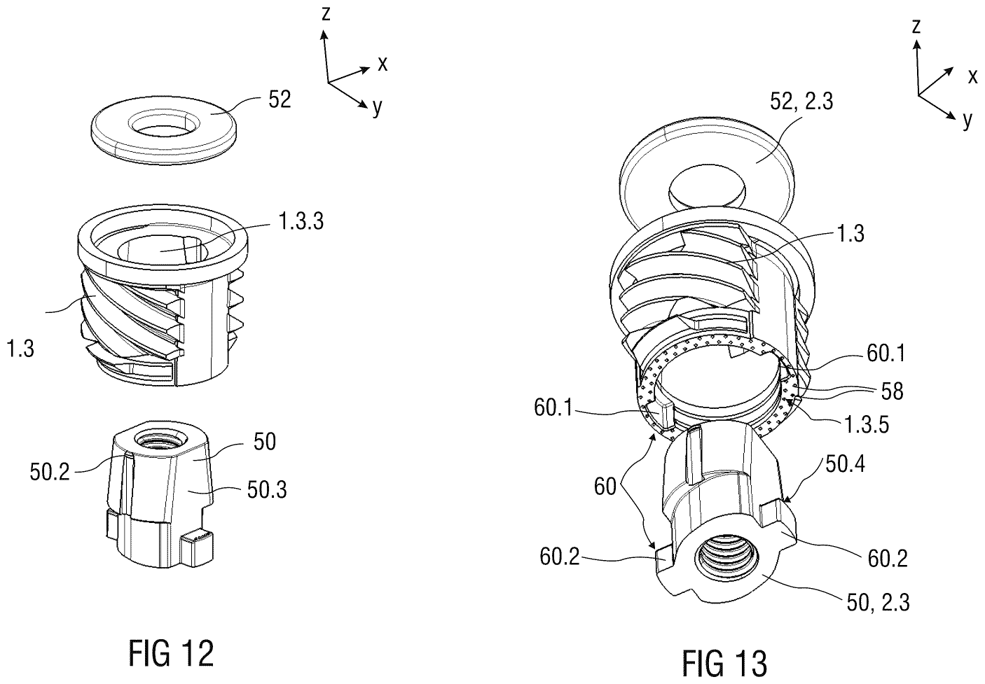

FIG. 12 shows a schematic exploded representation of the third embodiment of the partial installation module 10.3 according to FIG. 11 with the separate stop ring 52 and the compensating element 1.3 with the conical clamping surface 1.3.3. The second nut element 50 has complementary clamping surfaces 50.3 on the outer contour, by means of which the compensating element 1.3 can be expanded during installation in order to engage in the base element 4.1, as previously described with reference to the installation sequence according to FIGS. 6 to 7.

FIG. 13 shows a further schematic exploded representation of the third embodiment of the partial installation module 10.3 according to FIGS. 11 and 12. In addition, the compensating element 1.3 and the second nut element 50 can comprise clamping elements 58, in particular knobs, lugs or the like, on mutually facing end surfaces 1.3.5 and 50.4, respectively. The clamping elements 58 protrude axially from the front surfaces 1.3.5, 50.4.

Furthermore, an anti-twisting device 60 (also called rotation protection) can be provided. The anti-twisting device 60 is designed, for example, as an inner groove 60.1 in the compensating element 1.3 and as a radial projection 60.2 that engages in the inner groove 60.1 in the assembled state of the compensating element 1.3 and the second nut element 50, so that they are coupled together in a rotationally fixed manner.

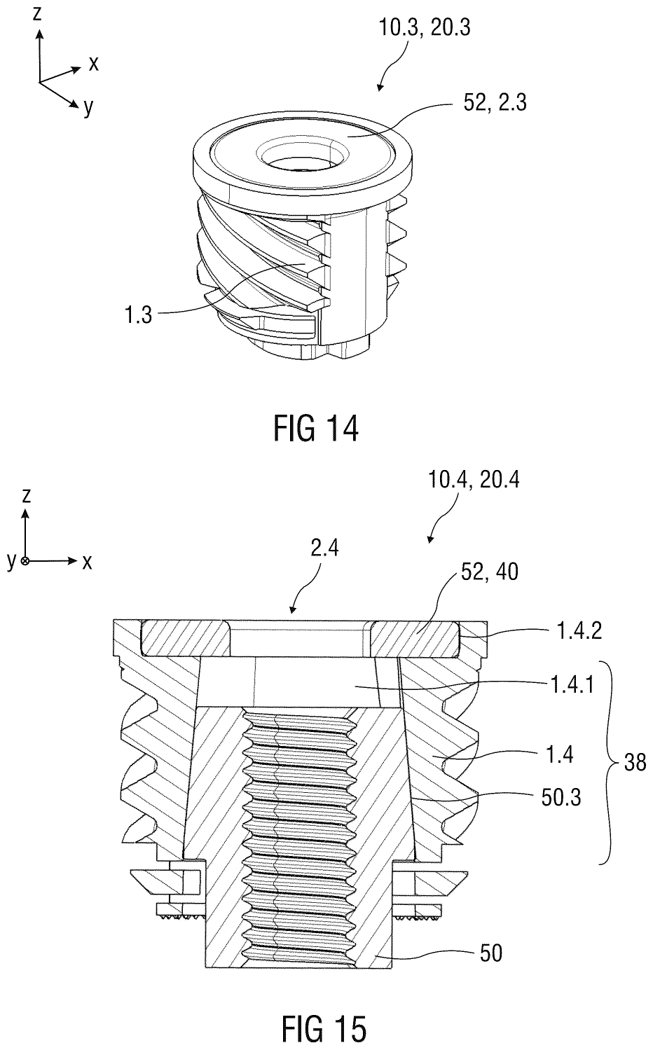

FIG. 14 shows a schematic perspective representation of the third embodiment of the partial installation module 10.3 according to FIGS. 11 to 13.

FIG. 15 shows a schematic sectional representation of a fourth embodiment of a compensating element 1.4 with a mating connecting element 2.4 as a pre-installable partial installation module 10.4 of a device 20.4 for compensating for tolerances.

The device 20.4 of this fourth embodiment differs only in the design of the compensating element 1.4 and the mating connecting element 2.4. The functions and installation sequence of the device 20.4 according to the fourth embodiment are analogous to the device 20.1 of the first embodiment.

The compensating element 1.4 is designed in one piece. The compensating element 1.4 has conical clamping surfaces 1.4.1 as its inner contour. The second nut element 50 has complementary clamping surfaces 50.3 on the outer contour, by means of which the compensating element 1.4 can be expanded during installation in order to engage in the base element 4.1, as previously described with reference to the installation sequence according to FIG. 6 to 7.

The mating connecting element 2.4 comprises the separate stop ring 52 as a stop flange 40 of the axial interference fit 38. The separate stop ring 52 is arranged and held in a front-side receptacle 1.4.2 of the compensating element 1.4 in a form-locking and/or force-locking manner.

During installation and clamping, the second nut element 50 is clamped with its conical clamping surfaces 50.3 against the separate stop ring 52 and against the conical clamping surfaces 1.4.1 of the compensating element 1.4.

As a result, the compensating element 1.4 is stretched outwards so that a radial play between the base element 4.1 (integrated in the component 12) and the compensating element 1.4 can be compensated for.

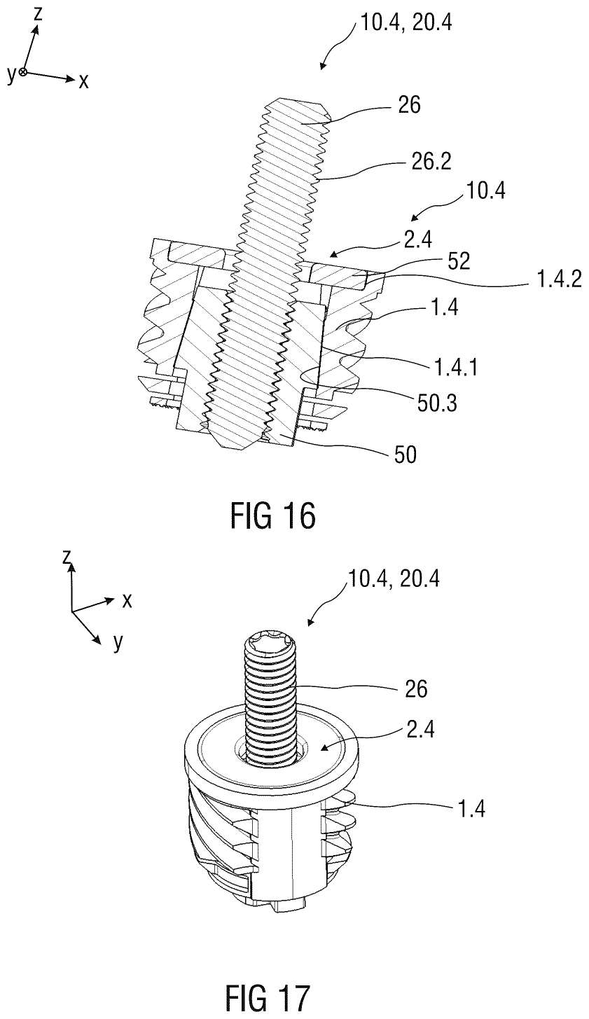

FIG. 16 shows a further schematic sectional representation of the partial installation module 10.4 with a screwed-in connecting element 26, in particular a stud bolt having a screw thread 26.2 according to the fourth embodiment as shown in FIG. 15. The compensating element 1.4 and the second nut element 50 are wedged together in a form-locking and force-locking manner by means of the conical clamping surfaces 50.3 and 1.4.1.

FIG. 17 shows a schematic perspective representation of the fourth embodiment as shown in FIG. 16 in the assembled state with compensating element 1.4, mating connecting element 2.4 and screwed-in connecting element 26.

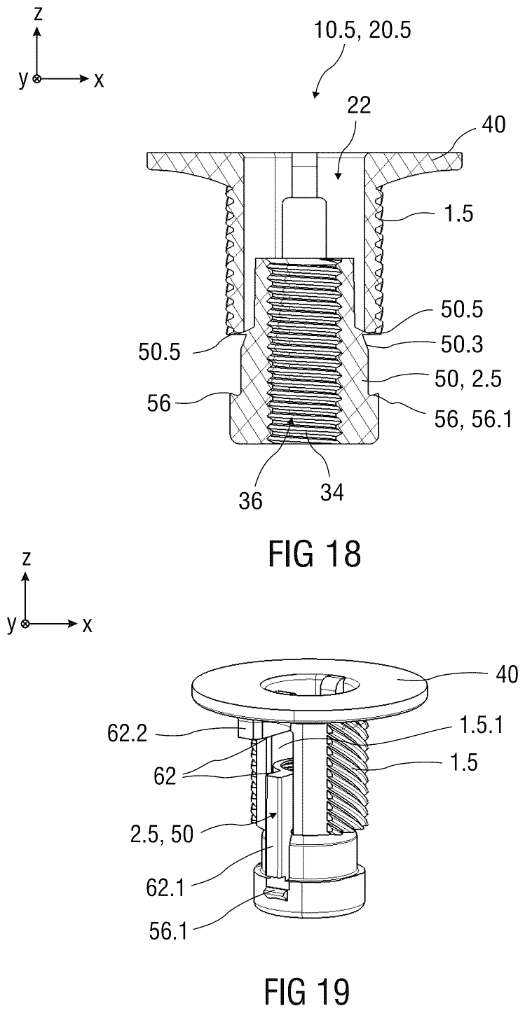

FIG. 18 shows a schematic sectional representation of a fifth embodiment of a compensating element 1.5 with a mating connecting element 2.5 as a pre-installable partial installation module 10.5 of a device 20.5 for compensating for tolerances.

The device 20.5 of this fifth embodiment differs only in the design of the compensating element 1.5 and the mating connecting element 2.5. The functions and installation sequence of the device 20.5 according to the fifth embodiment are analogous to the device 20.1 of the first embodiment.

The compensating element 1.5 is designed in one piece. The compensating element 1.5 has the first through-opening 22 and the stop flange 40. The second nut element 50 has conical clamping surfaces 50.3 on the outer contour, by means of which the compensating element 1.5 can be expanded during installation in order to engage in the base element 4.1, as previously described with reference to the installation sequence according to FIGS. 6 to 7.

The mating connecting element 2.5 comprises the second nut element 50, the outer contour of which is stepped in the axial direction and the through-opening 36 of which is provided with the internal nut thread 34. In addition, the second nut element 50 can have releasable auxiliary couplings 50.5 as a captive securing means. The auxiliary couplings 50.5 are designed, for example, as molded connections between the second nut element 50 and the compensating element 1.5, so that they are coupled together in a captive manner upon delivery and before final installation.

During installation and clamping, the second nut element 50 is clamped with its conical clamping surfaces 50.3 against the compensating element 1.5. As a result, the compensating element 1.5 is stretched outwards so that a radial play between the base element 4.1 (integrated in the component 12) and the compensating element 1.5 can be compensated for.

In addition, the device 20.5 can have a transport lock 56 for the loss-proof arrangement of the compensating element 1.5 and the mating connecting element 2.5. The transport lock 56 can, for example, be designed as an outward-facing securing edge 56.1.

FIG. 19 shows a schematic perspective representation of the fifth embodiment according to FIG. 18.

The device 20.5 may comprise complementary stop surfaces 62 between the stop flange 40 and the second nut element 50. The stop surfaces 62, in particular a longitudinal web 62.1 projecting radially from the second nut element 50 and a stop web 62.2 extending axially from an underside of the stop flange 40, rest axially against one another in the final installed state.

FIG. 20 shows a schematic exploded representation of the partial installation module 10.5 of the device 20.5 of the fifth embodiment according to FIG. 18 with a separate base element 4.2 and the component 12 to be connected.

The fifth embodiment is different in that the component 12 and the base element 4.2 are separate components. As a result, the partial installation module 10.5 can additionally enclose the base element 4.2 in a captive manner, as shown in FIG. 22.

The base element 4.2 has a coupling interface 4.2.1, by means of which the base element 4.2 can be connected to the component 12 in a form-locking and/or force-locking manner in the component opening 12.1. The component 12 has a mating coupling interface 12.2 in the component opening 12.1.

The coupling interface 4.2.1 and the mating coupling interface 12.2 are, for example, designed to establish a detachable connection between the basic element 4.2 and the component 12. For example, the coupling interface 4.2.1 and the mating coupling interface 12.2 in the connected state can form a bayonet connection (as shown), a screw connection, a snap connection, a clip connection or the like between the base element 4.2 and the component 12. Alternatively, the base element 4.2 can also be glued into the component opening 12.1. In the illustrated, in particular fixed and detachable, bayonet connection, the base element 4.2 is first inserted into the component opening 12.1 in the insertion direction 100 and then rotated according to arrow 106.

The separate base element 4.2 can further comprise flexible support elements 64, in particular support arms. Furthermore, the separate base element 4.2 can be designed in a funnel shape in the insertion direction 100 at the front entrance 4.2.3 to an associated through-opening 4.2.2. The internal thread 30 is arranged in the through-opening 4.2.2, into which the external thread 28 of the compensating element 1.5 engages during assembly.

The longitudinal web 62.1 of the mating connecting element 2.5 is arranged in a longitudinal groove 1.5.1 of the compensating element 1.5. As a result, the compensating element 1.5 is guided in the compensating direction 104 during its axial compensation movement.

The component 12 can also have an inner contour of the component opening 12.1 adapted to the outer contour of the base element 4.2.

Analogous to the transport lock 56 of the compensating element 1.2 and the mating connecting element 2.2, the base element 4.2 can be held in a captive manner on the partial installation module 10.5 by means of a flexible securing arm 56.2 on the transport lock 56.

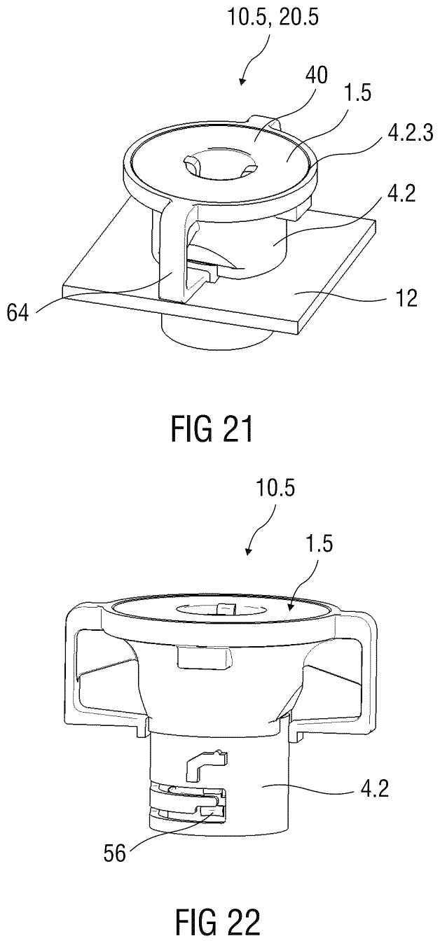

FIG. 21 shows a schematic perspective representation of the partial installation module 10.5 of the device 20.5 of the fifth embodiment as shown in FIG. 20 in the partially installed state on the component 12. The connecting element 26 and the other component 14 are then connected to the partial installation module 10.5 and the component 12 in a tolerance-compensating manner, in particular compensating for axial and/or radial component tolerances, as described with reference to FIGS. 6 and 7.

The support elements 64 of the separate base element 4.2 rest on the component 12. The stop flange 40 of the compensating element 1.5 lies flush in the funnel-shaped entrance 4.2.3 and serves as a stop for the other component 14 to be connected (shown in FIGS. 5 to 7).

FIG. 22 shows a schematic side view of the partial installation module 10.5 with the components held in a captive manner by means of the transport lock 56 and pre-installed with one another: base element 4.2, compensating element 1.5 and mating connecting element 2.5 of the fifth embodiment as shown in FIGS. 18 and 20.

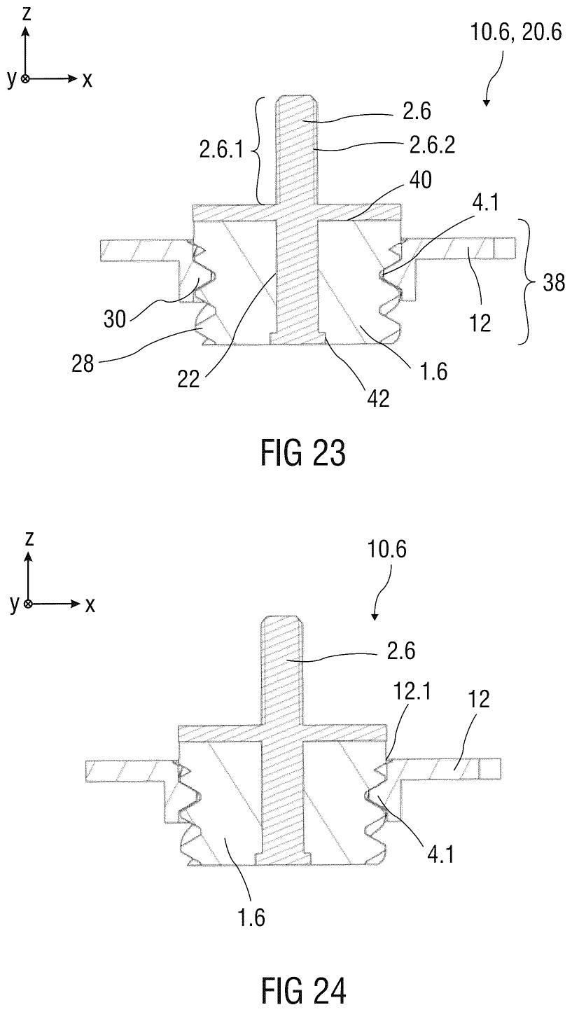

FIG. 23 shows a schematic sectional representation of a sixth embodiment of a compensating element 1.6 with a mating connecting element 2.6 as a pre-installable partial installation module 10.6 of a device 20.6 for compensating for tolerances.

The partial installation module 10.6 is pre-installed on the component 12 by means of the integrated base element 4.1.

Analogous to the first embodiment, the compensating element 1.6 and the mating connecting element 2.6 are designed to be axially firmly connected to one another by means of the interference fit 38. The mating connecting element 2.6 has the stop flange 40 and the shoulder 42 for the form-locking coupling with the compensating element 1.6. On a circumferential side of the first through-opening 22, the compensating element 1.6 has a profile complementary to the stop flange 40 and the shoulder 42, so that these are coupled to one another by means of the axial interference fit 38.

The mating connecting element 2.6 can be injected into the compensating element 1.6 in the region of the first through-opening 22 or can also be formed in one piece with the compensating element 1.6.

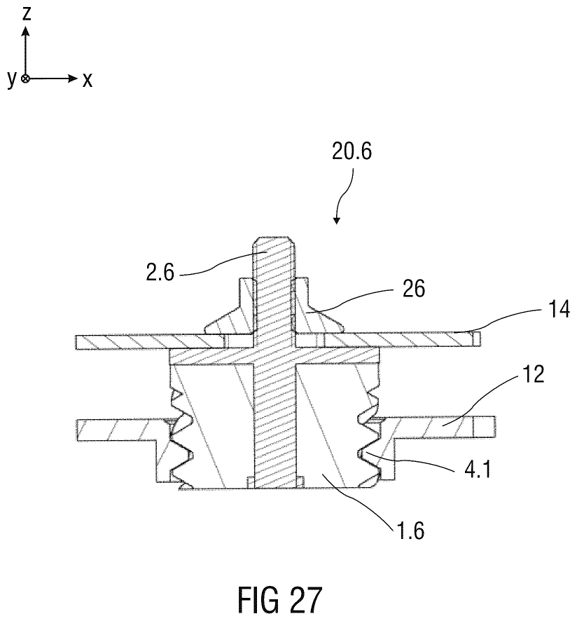

The mating connecting element 2.6 has a connecting section 2.6.1 that projects perpendicularly from the stop flange 40. The connecting section 2.6.1 is provided as a screw portion with a metric thread 2.6.2 on which a nut can be placed as a connecting element 26 instead of the previously described screw, as shown in FIGS. 26 and 27.

The compensating element 1.6 has the external thread 28 having a steep thread pitch, which engages with the internal thread 30 of the integrated base element 4.1.

FIGS. 24 to 27 show an installation sequence for connecting the two components 12, 14 by means of the device 20.6 for compensating for tolerances according to the sixth embodiment.

The component 12 has the integrated basic element 4.1. The partial installation module 10.6 comprising the compensating element 1.6 and the pre-installed mating connecting element 2.6 is installed in the component 12, in particular in the component opening 12.1 and in the base element 4.1 integrated on the inside of the component opening 12.1, as shown in FIG. 24.

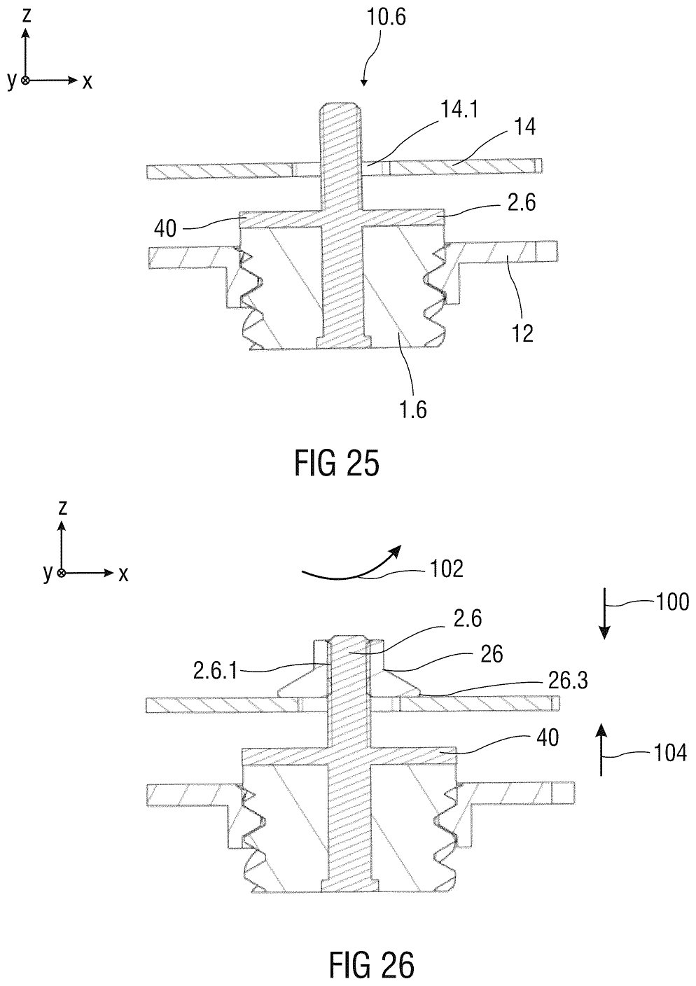

According to FIG. 25, the component 12 having the pre-installed partial installation module 10.6 consisting of the installed compensating element 1.6 and the installed mating connecting element 2.6 is brought into position with respect to the other component 14. The other component 14 can have a larger component opening 14.1 due to the stop flange 40 of the mating connecting element 2.6. This allows for radial compensation of component tolerances.

According to FIG. 26, the connecting element 26, in particular a nut, is placed, in particular screwed and thereby rotated, for example, according to arrow 102, onto the connecting portion 2.6.1 of the mating connecting element 2.6 in the insertion direction 100.

The connecting element 26 rotates onto the connecting portion 2.6.1 until a lower stop surface 26.3 of the connecting element 26 comes into contact with the other component 14. When the connecting element 26 is further tightened and rotated, a torque is exerted on the compensating element 1.6 via the mating connecting element 2.6, which causes the compensating element 1.6 to be axially unscrewed from the base element 4.1 against the insertion direction 100 of the connecting element 26 in the compensating direction 104 and thus compensates for axial tolerances until the stop flange 40 rests against the component 14.

FIG. 27 shows the device 20.6 in the final installed state, in which the connecting element 26, the mating connecting element 2.6 and the component 14 are clamped together and the axial tolerances are compensated for. The component 12 is connected to the compensating element 1.6 via the base element 4.1 in a form-locking manner.

FIG. 28 shows a schematic sectional representation of a seventh embodiment of a multi-part compensating element 1.7 with a multi-part mating connecting element 2.7 as a pre-installable partial installation module of a device 20.7 for compensating for tolerances between two components 12, 14 to be connected to one another (shown in FIGS. 6 and 7).

The multi-part compensating element 1.7 is formed, for example, from at least two segments 1.7a, 1.7b, which are axially displaceable relative to one another. The compensating element 1.7, in particular each segment 1.7a, 1.7b, has as an external thread 28 corresponding steep thread turn portions, in particular with the same pitch. In particular, the compensating element 1.7 has, as an external thread 28, a multi-turn thread having multiple thread turns 28.1 to 28.n on the outside, which multi-turn thread has multiple groups of steep thread turn portions arranged parallel to one another and distributed in the circumferential direction.

The multi-part mating connecting element 2.7 is arranged in the first through-opening 22 of the compensating element 1.7. The multi-part mating connecting element 2.7 comprises the separate stop ring 52 as a T-profile and the separate second nut element 50 having the metric internal nut thread 34. The internal nut thread 34 is not a steep thread.

The separate stop ring 52 has a passage 52.2 for the connecting element 26 (shown in FIG. 7), wherein the dimensions of the passage 52.2 are larger than the dimensions of the internal nut thread 34 of the second nut element 50, so that the connecting element 26 can be screwed through the stop ring 52 and into the second nut element 50 without engagement. The stop ring 52 has a stop flange 52.3, which is formed at least in portions in contact with the compensating element 1.7. At its inner end, the stop ring 52 has a holding shoulder 52.4 or holding portions that point radially outward. The retaining shoulder 52.4 serves to ensure a form-locking and axially fixed arrangement of the stop ring 52 in the compensating element 1.7.

In summary, the at least one external thread turn 28.n of the compensating element 1.7 has in particular a higher thread pitch than the metric internal nut thread 34 of the inner mating connecting element 2.7. The at least one external thread turn 28.n has, for example, a steep pitch angle of greater than or equal to 5⁰ relative to a horizontal or preferably greater than or equal to 10° relative to the horizontal, wherein the following generally applies:

thread pitch PH>nominal diameter/3

This design of the external thread 28 can also be used for the other embodiments of the compensating element 1.1 to 1.6 and 1.8.

In addition, the particular external thread 28 of the various compensating elements 1.1 to 1.8 can be designed as a steep thread that has no self-locking. For example, the particular external thread 28 can be formed in portions from multiple individual thread turns 28.1 to 28.n of the same pitch.

The particular compensating element 1.1 to 1.8 has, for example, as an external thread 28, a thread that is not continuous but is formed by multiple, for example two, four or six or the like, thread turns 28.1 to 28.n (also referred to as thread turn portions) arranged evenly distributed in the circumferential direction. All individual thread turns 28.1 to 28.n or thread portions have the same pitch, which is chosen to be large enough for the external thread 28 to form the steep thread.

The inner mating connecting element 2.7 with the internal nut thread 34 as an inner metric thread (also referred to as an internal metric nut thread 34 or a metric internal nut thread 34) has a standardized thread having metric dimensions, for example a metric flank angle of 60° and a metric thread pitch PH=P for a standard thread M5 of 0.8 mm, M6 of 1.0 mm or M8 of 1.25.

For example, the internal nut thread 34 has the following parameters, wherein preferably:

$$thread pitch PH < nominal diameter / 4$$

with a resulting pitch angle of less than 4°.

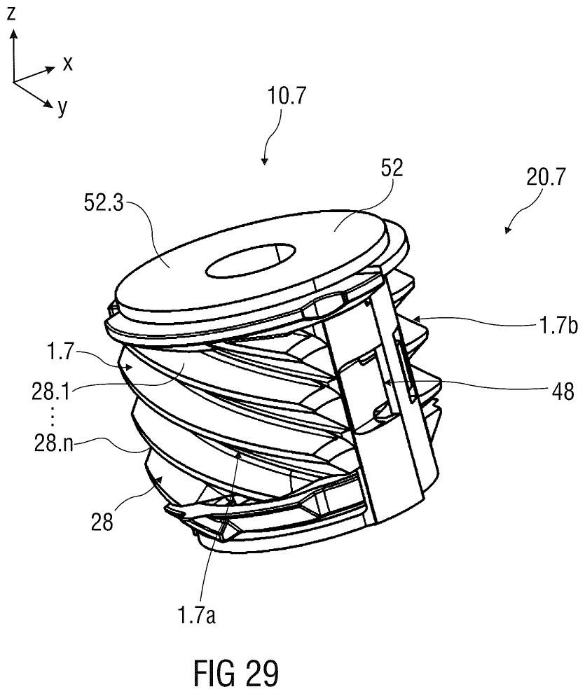

FIG. 29 shows a schematic perspective view of the seventh embodiment with the compensating element 1.7 having the non-self-locking steep external thread 28 having individual thread turns 28.1 to 28.n as thread turn portions. The stop flange 52.3 rests on the outside of an end face of the compensating element 1.7, at least in portions.

The segments 1.7a, 1.7b can be releasably connectable or connected to one another by means of the coupling connection 48 described above, for example a clip connection or a snap connection.

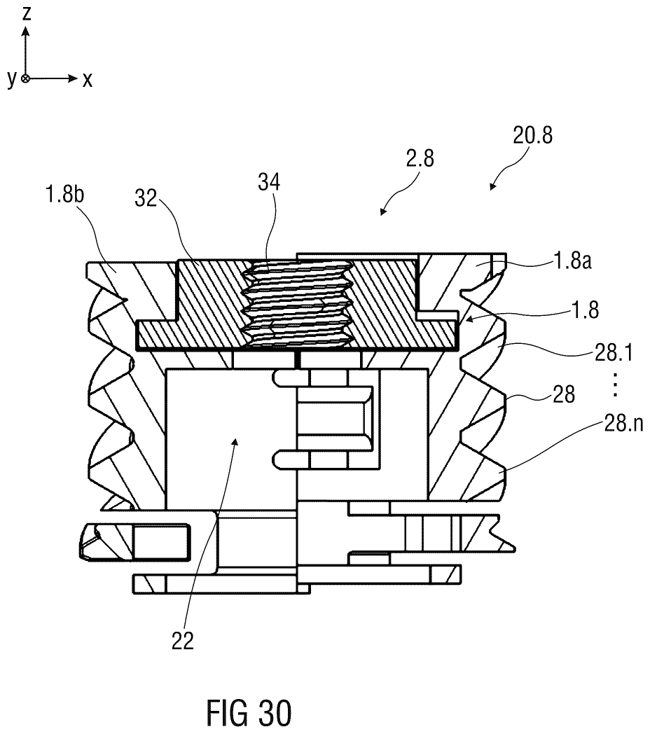

FIG. 30 shows a schematic sectional representation of an eighth embodiment of a compensating element 1.8 with a mating connecting element 2.8 as a pre-installable partial installation module of a device 20.8 for compensating for tolerances between two components 12, 14 to be connected to one another (shown in FIGS. 6 and 7). The device 20.8 differs from the device 20.7 in that the mating connecting means 2.8 arranged in the through-opening 22 is formed in one part and comprises the first nut element 32 having an internal nut thread 34.

The compensating element 1.8 is designed analogously to the compensating element 1.7 according to FIGS. 28 and 29. The compensating element 1.8 comprises segments 1.7a, 1.7b, which can be detachably connected by means of the coupling connection 48. The compensating element 1.8 comprises a non-self-locking steep thread as an external thread 28, said steep thread having individual steep thread turns 28.1 to 28.n, as described above.

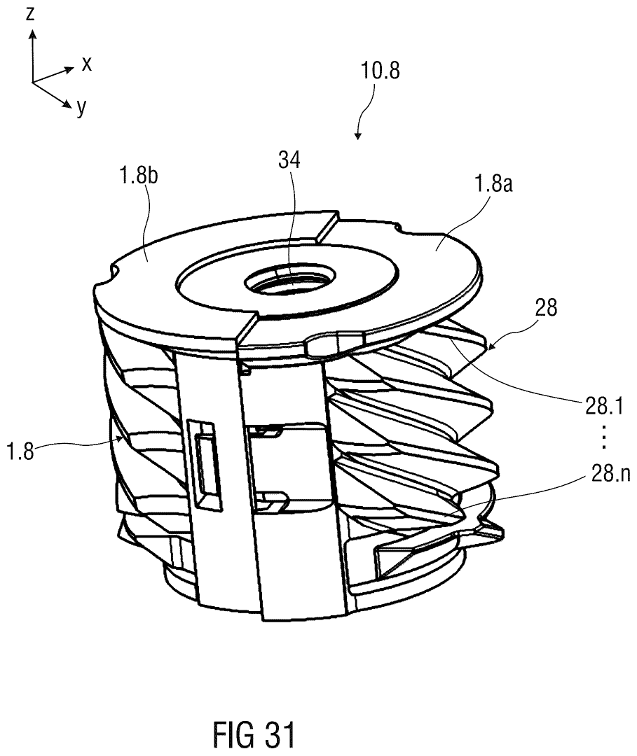

FIG. 31 shows a schematic perspective view of the eighth embodiment with the compensating element 1.8 having the external thread 28 having the individual steep threads 28.1 to 28.n and the first nut element 32, which is arranged in the compensating element 1.8. The nut element 32 is arranged in the compensating element 1.8 such that the nut element 32 is at least flush with one of the segments 1.7a.

The following generally applies to all embodiments: The particular internal nut thread 34 of the mating connecting element 2.1 to 2.8 is therefore not designed as a steep thread. The internal nut thread 34 is self-locking. The external thread 28 of the particular compensating element 2.1 to 2.8 is formed as a steep thread, in particular in portions from multiple individual thread turns 28.1 to 28.n of the same pitch. The external thread 28 is not self-locking.

### LIST OF REFERENCE SIGNS

1.1 to 1.8 Compensating element
1.2.1, 1.2.2 Housing shell
1.2.3 Receptacle
1.2.4 Latching edge
1.2.5 Conical clamping surface
1.3.1, 1.3.2 Housing shell
1.3.3 Conical clamping surface
1.3.4 Stop surface
1.3.5 Front surface
1.4.1 Conical clamping surface
1.4.2 Receptacle
1.5.1 Longitudinal groove
1.7a, 1.7b Segment
2.1 to 2.8 Mating connecting element
2.6.1 Connecting portion
2.6.2 Thread
4.1, 4.2 Base element
4.2.1 Coupling interface
4.2.2 Through-opening
4.2.3 Entrance
10.1 to 10.6 Partial installation module
11 Partial installation assembly
12 Component
12.1 Component opening
12.2 Mating coupling interface
14 Component
14.1 Component opening
20.1 to 20.8 Device for compensating for tolerances
22 First through-opening
26 Connecting element
26.1 Head
26.2 Screw thread
26.3 Lower stop surface
28 External thread
28.1 to 28.n Thread turns
30 Internal thread
32 First nut element
34 Internal nut thread
36 Second through-opening
38 Axial interference fit
40 Stop flange
42 Shoulder
44 Smooth circumferential region
46 Dividing line
48 Coupling connection
48.1 Latching arm
48.2 Latching hook
48.3 Latching receptacle
50 Second nut element
50.1 Radial collar
50.2 Latching clip
50.3 Conical clamping surface
50.4 Front surface
50.5 Auxiliary coupling
52 Stop ring
52.1 Latching lug
52.2 Passage
52.3 Stop flange
52.4 Holding shoulder
54 Front receptacle
56 Transport lock
56.1 Securing edge
56.2 Securing arm
58 Clamping element
60 Anti-twisting device
60.1 Inner groove
60.2 Radial projection
62 Complementary stop surface
62.1 Longitudinal web
62.2 Stop web
64 Support element
100 Insertion direction
102 Arrow
104 Compensating direction
106 Arrow

What is claimed is:

1. A device for compensating for tolerances between two components to be connected to one another, wherein the device comprises:
a base element for fastening to one of the components and
a compensating element that is arranged in the base element in an axially movable and adjustable manner to compensate for tolerances relative to the base element, and
wherein the compensating element has a through-opening in which a mating connecting element for a connecting element is arranged,
wherein the mating connecting element and the compensating element are set up in relation to one another in such a way that the compensating element for compensating for axial tolerances between the two components is movable relative to the base element in the compensation direction opposite to the insertion direction, and
wherein the compensating element has a self-locking external thread on the outside and the mating connecting element has a non-self-locking internal nut thread.

2. The device according to claim 1,
wherein the compensating element and/or the mating connecting element are/is formed in multiple parts.

3. The device according to claim 1,
wherein the external thread is formed in portions from multiple individual thread turns of the same pitch.

4. The device according to claim 1,
wherein the external thread of the compensating element is designed as a steep thread and the internal nut thread of the mating connecting element is designed as a metric thread.

5. The device according to claim 1,
wherein the compensating element is held in an axially immovable manner relative to the mating connecting element or the mating connecting element is held in an axially immovable manner relative to the compensating element.

6. The device according to claim 1,
wherein the mating connecting element and the compensating element are coupled to one another in a form-locking manner.

7. The device according to claim 6,
wherein the mating connecting element is designed as a threaded nut with the internal nut thread and has on the one hand a stop flange and on the other hand a radial shoulder for coupling with the compensating element in a form-locking manner.

8. The device according to claim 1,
wherein the mating connecting element can be axially clamped against the compensating element or vice versa.

9. The device according to claim 8,
wherein the compensating element on an inner side of the through-opening and/or the mating connecting element on an outer side of the outer circumference have or has clamping surfaces that are conical at least in some regions.

10. The device according to claim 8,
wherein the mating connecting element can be axially clamped against a stop ring fixed in the through-opening or a stop flange on an inner wall of the through-opening of the compensating element.

11. The device according to claim 1,
wherein the mating connecting element is designed as a threaded nut with the internal nut thread or a screw with a connecting portion and has a radial shoulder and wherein the compensating element is designed with a counter-shoulder for coupling with the shoulder in a form-locking manner.

12. The device according to claim 1,
wherein, when the mating connecting element and the compensating element are axially clamped, the compensating element can be expanded radially outward and comes into play-free engagement with the base element.

13. The device according claim 1,
wherein the base element is formed separately and has a coupling interface for one of the components and/or the base element is integrated or pre-installed in one of the components.
